(19) United States
(12) Patent Application Publication
(10) Pub. No.: US 2008/0014824 A1
(43) Pub. Date: Jan. 17, 2008

(54) MANUFACTURING METHOD AND MANUFACTURING APPARATUS FOR IMAGE DISPLAY DEVICE

(76) Inventors: Takashi Enomoto, Fukaya-shi (JP); Katsumi Omote, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/690,901

(22) Filed: Mar. 26, 2007

Related U.S. Application Data
(63) Continuation of application No. PCT/JP05/16963, filed on Sep. 14, 2005.

(30) Foreign Application Priority Data
Sep. 29, 2004 (JP) 2004-284283

(51) Int. Cl. H01J 9/32; H01J 9/46

(52) U.S. Cl. 445/25; 445/66

(57) ABSTRACT

In a manufacturing method for an image display device, one of a pair of substrates is provided with a reinforcing member, these substrates are located opposite each other with the reinforcing member and a space therebetween, the pair of opposed substrates are heated, the pair of substrates are then cooled in a manner such that the space between the pair of substrates is narrower than the space for the heating operation and that radiant heat from the other substrate is applied to the reinforcing member, and respective peripheral edge portions of the pair of cooled substrates are sealed together.

### CROSS REFERENCE TO RELATED APPLICATIONS

This is a Continuation Application of PCT Application No. PCT/JP2005/016963, filed Sep. 14, 2005, which was published under PCT Article 21(2) in Japanese.

This application is based upon and claims the benefit of priority from prior Japanese Patent Application No. 2004-284283, filed Sep. 29, 2004, the entire contents of which are incorporated herein by reference.

### BACKGROUND OF THE INVENTION

1. Field of the Invention

This invention relates to a manufacturing method and a manufacturing apparatus for an image display device provided with a vacuum envelope having substrates opposed to each other and reinforcing members located between respective plate surfaces of the substrates.

2. Description of the Related Art

In recent years, a liquid crystal display (LCD), field emission display (FED), plasma display panel (PDP), etc., have been known as image display devices with a flat envelope of a flat panel structure. Further, a surface-conduction electron-emitter display (SED) that comprises surface-conduction electron emitting elements has been developed as a kind of FED.

The SED comprises a front substrate and a rear substrate that are opposed to each other with a predetermined space between them. These substrates have their respective peripheral portions joined together by a rectangular sidewall in the form of a rectangular frame, thereby constituting a flat vacuum envelope of a flat panel structure of which the inside is kept at a vacuum. A plurality of spacers to serve as reinforcing members are provided between the front substrate and the rear substrate in order to withstand the atmospheric load that acts on these substrates.

Three-color phosphor layers are formed on the inner surface of the front substrate. Arrayed on the inner surface of the rear substrate are a large number of electron emitting elements for use as electron emission sources, which correspond to pixels, individually, and excite the phosphor layers to luminescence. A large number of wires for driving the electron emitting elements are provided in a matrix on the inner surface of the rear substrate, and their respective end portions are led out of the vacuum envelope.

In operating this SED, a high voltage of about 10 kV is applied between the substrates, and a driving voltage is applied selectively to the electron emitting elements through a driver circuit that is connected to the wires. Thereupon, electron beams are emitted alternatively from the electron emitting elements, and these electron beams are applied to the phosphor layers. The phosphor layers are excited to luminescence and display a color image.

In the SED of this type, the display device can be thinned to a thickness of about several millimeters and made lighter in weight and thinner than a cathode-ray tube (CRT) that is currently used as a display of a TV or a computer.

Various manufacturing methods have been examined to manufacture the vacuum envelope of the SED described above. According to a manufacturing method disclosed in Jpn. Pat. Appln. KOKAI Publication No. 2002-319346, for example, an entire vacuum apparatus is exhausted to a high vacuum as a front substrate and a rear substrate that are spaced at a sufficient distance from each other are baked in the vacuum apparatus. A method may be suggested to join the front substrate and the rear substrate by means of a sidewall when a predetermined temperature and degree of vacuum are reached. In this method, low-melting-point metal is used as a sealant with which a seal can be made at a relatively low temperature.

In the SED constructed in this manner, the spacers as reinforcing members, which support atmospheric pressure (vacuum pressure) acting on the front substrate and the rear substrate of the vacuum envelope, are thin plates that are located in an upright state. Each spacer has at least one retaining portion that is held on the substrates. Each spacer extends to the outside of an image display region lest its retaining portion lower the image display performance, and the retaining portion is provided on the peripheral portion of the spacer outside the image display region.

Processes for manufacturing the vacuum envelope having these spacers therein include heat treatment processes, such as a baking process, in which the substrates are previously heated to a temperature of, e.g., about 400° C. to discharge surface-adsorbed gas lest unnecessary gas be generated from the substrates during the operation of the display device, and a cooling process, in which the substrates are cooled to a temperature of, e.g., about 120° C., thereafter.

If an attempt is made to shorten the substrate cooling time by using cooling plates or the like in a heat treatment process, a substantial difference in temperature is caused between the substrates and the spacers in the heat treatment process concerned. There is a problem that a difference in thermal expansion attributable to this temperature difference may cause a failure, such as disengagement of the spacers from the substrates or their breakage. Thus, in order to prevent this failure, the time period for the heat treatment process must be lengthened to permit slower cooling, which constitutes a substantial cause of reduction in productivity.

### BRIEF SUMMARY OF THE INVENTION

This invention has been made in consideration of these circumstances, and its object is to provide a manufacturing method and a manufacturing apparatus for an image display device, capable of efficiently manufacturing a vacuum envelope without causing any failure, such as disengagement or breakage of reinforcing members that support a vacuum pressure load acting between a front substrate and a rear substrate of the vacuum envelope.

According to an aspect of the invention, there is provided a method of manufacturing an image display device, which comprises an envelope which has a pair of substrates, opposed to each other and having respective peripheral edge portions sealed together, and reinforcing members interposed between the pair of substrates, the method comprising:

providing the reinforcing members on one of the pair of substrates; locating the pair of substrates opposite each other with the reinforcing member and a space therebetween; heating the substrates opposed to each other with the space therebetween; cooling the pair of substrates in a manner such that the space between the pair of substrates is narrower than the space for the heating operation and that radiant heat from the other substrate is applied to the reinforcing member; and sealing the respective peripheral edge portions of the pair of substrates together after the cooling.

According to another aspect of the invention, there is provided an apparatus for manufacturing an image display device, wherein a vacuum envelope of the image display device is manufactured by providing reinforcing members on one of a pair of substrates, opposing the pair of substrates to each other with the reinforcing member therebetween, and sealing together respective peripheral edge portions of the substrates inside which a vacuum is formed, the apparatus comprising:

heating means for heating the pair of substrates with respective plate surfaces thereof opposed to each other at a predetermined distance from each other; and cooling means for cooling the pair of heat-treated substrates in a manner such that the respective plate surfaces thereof are opposed closer to each other than in the heating operation and that a difference in temperature between the reinforcing member and the substrate which supports the reinforcing member is reduced by radiant heat from the substrate without the reinforcing member.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view showing a vacuum envelope of an SED according to an embodiment of this invention;

FIG. 2 is a sectional perspective view of the vacuum envelope broken away along line II-II of FIG. 1;

FIG. 3 is a partially enlarged sectional view partially enlargedly showing the profile of FIG. 2; and

FIG. 4 is a view showing a configuration of principal parts of a substrate manufacturing apparatus according to the embodiment of the present invention.

### DETAILED DESCRIPTION OF THE INVENTION

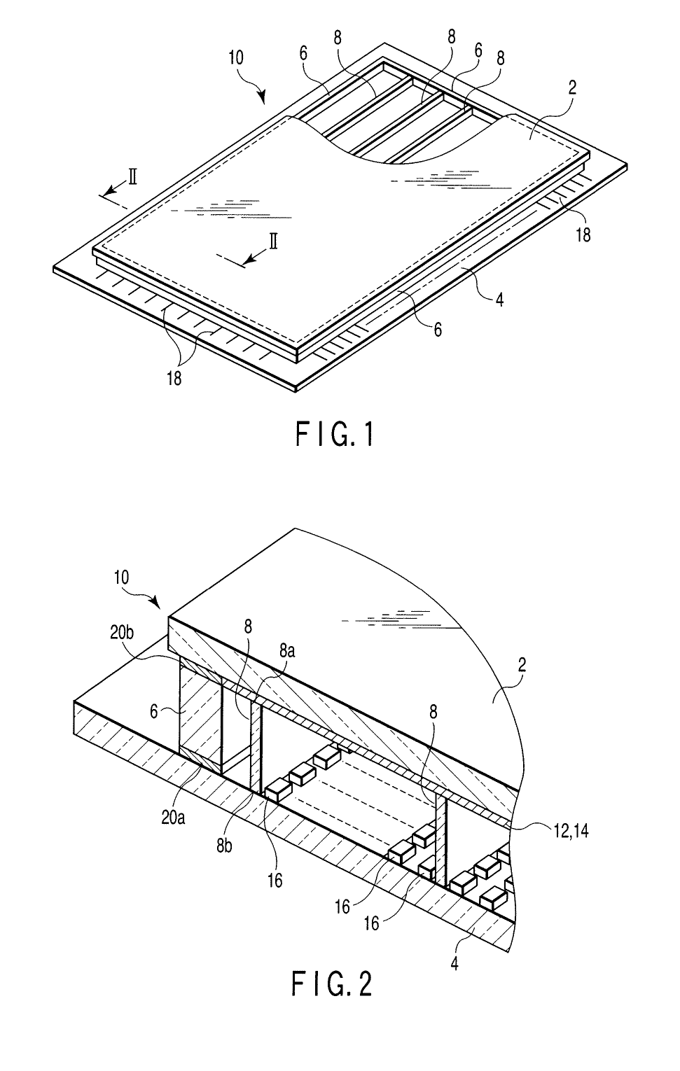

A manufacturing method for an image display device according to an embodiment of this invention will now be described in detail with reference to the accompanying drawings. First, a configuration of an SED will be described by way of example with reference to FIGS. 1 to 3.

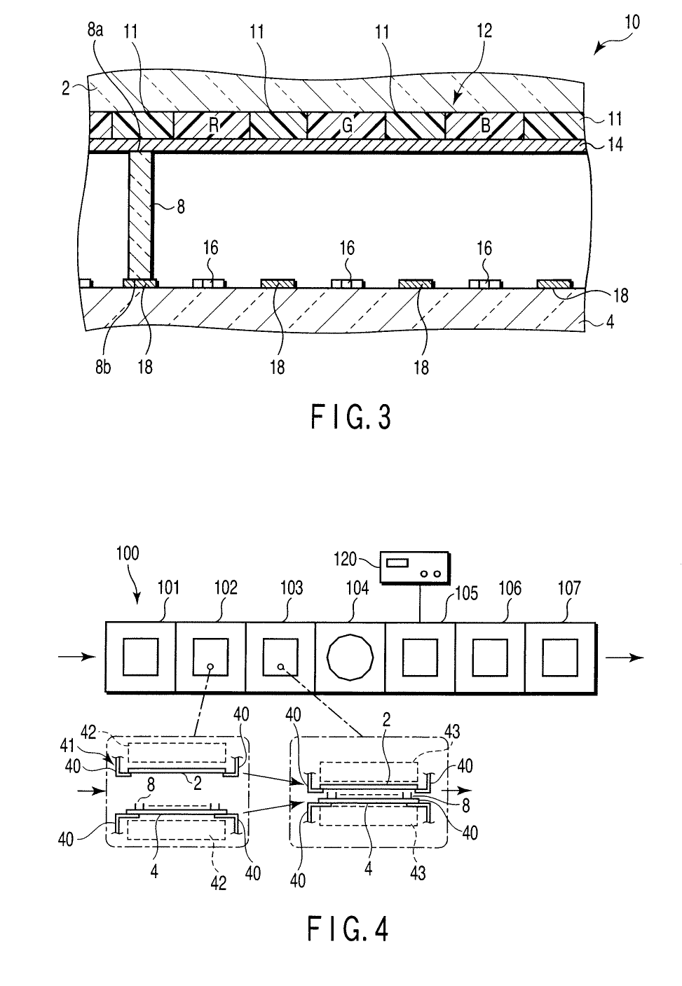

FIG. 1 is a perspective view showing a vacuum envelope 10 of the SED with a front substrate 2 partially broken away, FIG. 2 is a sectional view of the vacuum envelope 10 cut along line II-II of FIG. 1, and FIG. 3 is a partially enlarged sectional view partially enlargedly showing the profile of FIG. 2.

As shown in FIGS. 1 to 3, the SED comprises the front substrate 2 and a rear substrate 4, which are formed of a rectangular glass plate each. These substrates are opposed to each other in parallel relation with a gap of about 1.0 to 2.0 mm between them. The rear substrate 4 is one size larger than the front substrate 2. Further, the front substrate 2 and the rear substrate 4 have their respective peripheral edge portions joined together by a sidewall 6 in the form of a rectangular frame of glass, thereby constituting a flat vacuum envelope 10 of a flat panel structure of which the inside is kept evacuated.

A phosphor screen 12 that functions as an image display screen is formed on the inner surface of the front substrate 2. The phosphor screen 12 has red, blue, and green phosphor layers R, G and B and a light shielding layer 11 that are arranged side by side. These phosphor layers are stripe-shaped or dot-shaped. A metal back 14 of aluminum or the like is formed on the phosphor screen 12.

Provided on the inner surface of the rear substrate 4 are a large number of surface-conduction electron emitting elements 16 for use as electron sources, which individually emit electron beams that are used to excite the phosphor layers R, G and B of the phosphor screen 12 to luminescence. These electron emitting elements 16 are arrayed in a plurality of columns and a plurality of rows corresponding to pixels or the phosphor layers R, G and B. Each electron emitting element 16 is formed of an electron emitting portion (not shown), a pair of element electrodes that apply voltage to the electron emitting portion, etc. A large number of wires 18 for applying a driving voltage to the electron emitting elements 16 are provided in a matrix on the inner surface of the rear substrate 4, and their respective end portions are led out of the vacuum envelope 10.

The sidewall 6 that functions as a joint member is sealed to the peripheral edge portion of the front substrate 2 and the peripheral edge portion of the rear substrate 4 with sealants 20 (20a and 20b) of, for example, low-melting-point glass or low-melting-point metal, whereby these substrates are joined together. In the present embodiment, the rear substrate 4 and the sidewall 6 are joined together with fitted glass 20a, while the front substrate 2 and the sidewall 6 are joined together with indium 20b.

The SED comprises a plurality of spacers 8 that are located between the front substrate 2 and the rear substrate 4. These spacers 8 constitute reinforcing members for maintaining a vacuum withstand pressure, that is, for supporting atmospheric pressure (vacuum pressure) that acts between the substrates. In the present embodiment, the spacers 8 are in the form of elongate belts using thin glass plates and are arranged along a direction parallel to long sides of the rectangular rear substrate 4 in a manner such that they are set upright or at right angles to the substrate surfaces. Further, the plurality of spacers are arrayed at regular intervals in the direction of short sides of the rear substrate 4.

Each spacer 8 has opposite end portions that are situated outside an effective display region, and these opposite end portions are individually held on the rear substrate, for example. Further, each spacer 8 has an upper end 8a and a lower end 8b. The upper end 8a abuts against the inner surface of the front substrate 2 with the metal back 14 and the light shielding layer 11 of the phosphor screen 12 held between them. The lower end 8b abuts against the wires 18 on the inner surface of the rear substrate 4. The plurality of spacers 8 support an atmospheric load that acts on the front substrate 2 and the rear substrate 4 from outside the same and keep the space between the substrates at a predetermined value.

The SED comprises a voltage supply section (not shown) that applies an anode voltage between the metal back 14 of the front substrate 2 and the rear substrate 4. The voltage supply section applies the anode voltage between the rear substrate 4 and the metal back 14 so that potentials on the rear substrate 4 and the metal back 14 are set to zero and about 10 kV, respectively.

In displaying an image on the SED constructed in this manner, an anode voltage is applied across the element electrodes of the electron emitting elements 16 through a driver circuit (not shown) that is connected to the wires 18, electron beams are emitted from electron emitting portions of any desired ones of the electron emitting elements 16, and an anode voltage is applied to the metal back 14. The electron beams emitted from the electron emitting portions are accelerated by the anode voltage and collided with the phosphor screen 12. Thereupon, the phosphor layers R, G and B of the phosphor screen 12 are excited to luminescence and display a color image.

The following is a description of the manufacturing method for the SED constructed in this manner. First, in manufacturing the vacuum envelope 10 of the SED, the front substrate 2, which is provided with the phosphor screen 12 and the metal back 14, is prepared in advance. Further, the rear substrate 4, which is provided with the electron emitting elements 16 and the wires 18 and to which the sidewall 6 and the spacers 8 are joined, is prepared in advance. Then, the front substrate 2 and the rear substrate 4 are located in a vacuum chamber. After the vacuum chamber is evacuated, the front substrate 2 is joined to the rear substrate 4 with the sidewall 6 between them. Thus, the vacuum envelope of the SED with the plurality of spacers 8 is manufactured.

More specifically, an assembly process for the vacuum envelope includes heat treatment processes, such as a baking process, in which the substrates are previously heated to a temperature of about 400° C. to discharge gas adsorbed on the substrate surface, and a cooling process, in which the substrates are cooled to a temperature of about 120° C., thereafter.

FIG. 4 shows an example of a line configuration of a vacuum processing apparatus 100 that is provided in SED manufacturing processes and used to manufacture the vacuum envelope. The vacuum processing apparatus 100 comprises a load chamber 101, baking/electron-beam cleaning chamber 102, cooling chamber 103, vapor deposition chamber 104 for getter film, assembly chamber 105, cooling chamber 106, and unload chamber 107. Each chamber of the vacuum processing apparatus 100 is formed as a processing chamber capable of vacuum processing, and all the chambers are evacuated at the time of manufacture of the vacuum envelope 10. Further, these processing chambers are connected to one another by gate valves (not shown) or the like.

In the assembly process, the front substrate 2, which is provided with the phosphor screen 12 and the metal back 14, and the rear substrate 4, which is provided with the electron emitting elements 16, wires 18, sidewall 6, and spacers 8, are first put into the load chamber 101. After a vacuum is formed in the load chamber, the substrates are delivered to the baking/electron-beam cleaning chamber 102. In the baking/electron-beam cleaning chamber 102, the front substrate 2 and the rear substrate 4 are supported opposite each other across a gap by a support mechanism 41 that has a plurality of support arms 40. Further, the front substrate 2, the rear substrate 4, and various members including components mounted thereon are heated to a temperature of, e.g., about 400° C., by heating means, such as a hot plate 42 that is provided opposite the substrates, whereupon gas adsorbed on the surface of each substrate is degassed. The entire surfaces of the phosphor screen and the electron emitting elements are individually electron-beam-cleaned by deflection scanning with electron beams.

In concurrently baking the front substrate 2 and the rear substrate 4 in the baking process (heating process), if the location space between the respective plate surfaces of the front substrate 2 and the rear substrate 4 is narrow, gas that is degassed from the respective central parts of the substrates builds up without escaping to the outside, so that smooth degassing is difficult. Thus, the space between the respective plate surfaces of the front substrate 2 and the rear substrate 4 should preferably be made wide enough for satisfactory degassing (e.g., 100 mm or more).

In the baking process in the baking/electron-beam cleaning chamber 102, therefore, heat treatment is performed with the front substrate 2 and the rear substrate 4 in the chamber supported at a distance of, e.g., 100 mm or more from each other, which enables smooth degassing without leaving gas to stand between the substrates.

The front substrate 2 and the rear substrate 4, thus degassed, are supported by the support mechanism 41 as they are delivered to the cooling chamber 103, and are cooled to a temperature of, e.g., about 120° C. by cooling means, such as cooing plates 42, which are opposed to the front substrate 2 and the rear substrate 4, individually.

If an attempt is made to cool the substrates in a short time by using the cooling means in the cooling process, the spacers are cooled more quickly than the substrates, since the heat capacity of the spacers is extremely smaller than that of the substrates. Thus, the difference in temperature between the substrates and the spacers becomes so large that the spacers may be separated from the substrates or broken, so that the yield lowers considerably.

Accordingly, the space between the respective plate surfaces of the front substrate 2 and the rear substrate 4 in the vacuum chamber is widened in the baking process and narrowed in the cooling process thereafter.

In the cooling process in the cooling chamber 103, cooling is performed by cooling plates 43 as cooling means in a manner such that the space between the respective plate surfaces of the front substrate 2 and the rear substrate 4 in the chamber is approximated to a distance such that the spacers 8 supported on the rear substrate 4 can fully receive radiant heat from the front substrate 2 and be heated so that the spacer temperature is approximate to the temperature of the rear substrate 4 or that the difference in temperature between the rear substrate 4 and the spacers 8 cannot be excessive (or should be restricted within, e.g., 15° C.). This distance between the substrates is adjusted by means of the support mechanism 41.

The space between the respective plate surfaces of the front substrate 2 and the rear substrate 4, which varies depending on the shape and size of each substrate, heating and cooling time periods, temperature characteristics of the chamber atmosphere, etc., is adjusted to, e.g., 100 mm or more in the baking process and to, e.g., 20 mm or less in the subsequent cooling process. With use of this substrate cooling means that utilizes the radiant heat from the other substrate to be joined, the substrate cooling can be performed efficiently and quickly without requiring any special temperature control mechanism.

The front substrate 2 and the rear substrate 4 cooled in the cooling chamber 103 are delivered to the vapor deposition chamber 104 for getter film, in which a barium film is vapor-deposited as a getter film outside the phosphor layers. Subsequently, the front substrate 2 and the rear substrate 4 are delivered to the assembly chamber 105, in which indium to serve as a sealant is electrically heated to be melted by a power source 120, whereupon the substrates are sealed together to form the vacuum envelope. The sealed vacuum envelope is delivered to the cooling chamber 106, whereupon it is cooled to normal temperature and then taken out of the unload chamber 107. The vacuum envelope of the SED is manufactured by these processes.

In the baking process (heating process) in the baking/electron-beam cleaning chamber 102, as described above, baking is performed in a manner such that the space between the respective plate surfaces of the front substrate 2 and the rear substrate 4 in the chamber is widened to a distance such that degassing can be smoothly performed without leaving the gas degassed from the respective central parts of the front substrate 2 and the rear substrate 4 heat-treated by the heating means 42 to stand. In the subsequent cooling process in the cooling chamber 103, cooling is performed by means of cooling plates 43 with the space between the respective plate surfaces of the front substrate 2 and the rear substrate 4 in the chamber approximated to a distance such that the spacers 8 supported on the rear substrate 4 can fully receive radiant heat from the front substrate 2 so that the temperature of the spacers 8 having received the radiant heat is approximate to the temperature of the rear substrate 4. Thus, in the cooling process after the baking treatment, the substrate cooling by the cooling means 43 can be performed efficiently and quickly without exerting any bad influence on the baking treatment and without requiring any special temperature control mechanism. Accordingly, the difference in temperature between the substrates and the spacers thereon can be reduced so that the spacers can be prevented from being disengaged from the substrates or broken by the temperature difference. In consequence, SED products with high yield can be efficiently manufactured in a short period of time.

The present invention is not limited directly to the embodiment described above, and its components may be embodied in modified forms without departing from the spirit of the invention. Further, various inventions may be formed by suitably combining a plurality of components described in connection with the foregoing embodiment.

Although the manufacturing method for the SED has been described by way of example in connection with the foregoing embodiment, the present invention is also applicable to any other display panel structure in which electron emitting elements are located in a matrix. In the foregoing embodiment, the plurality of elongate spacers based on thin glass plates are located in an upright state at regular intervals along the long sides of the rectangular front and rear substrates between the substrates. Alternatively, however, the present invention is applicable to any other reinforcing members, such as configurations in which rectangular spacer members are arranged in a zigzag.

The substrate space, heating temperature, cooling temperature, etc. described in connection with the foregoing embodiment are given by way of example only. It is necessary only that appropriate values be set for the envelope that is manufactured according to various conditions, including the substrate material, substrate shape and size, heating/cooling time, temperature characteristics of the chamber atmosphere, etc., and the present invention may be applied to any of various types of display panels without departing from its spirit.

What is claimed is:

1. A method of manufacturing an image display device, which comprises an envelope which has a pair of substrates, opposed to each other and having respective peripheral edge portions sealed together, and reinforcing members interposed between the pair of substrates, the method comprising:
providing the reinforcing members on one of the pair of substrates;
locating the pair of substrates opposite each other with the reinforcing member and a space therebetween;
heating the substrates opposed to each other with the space therebetween;
cooling the pair of substrates in a manner such that the space between the pair of substrates is narrower than the space for the heating operation and that radiant heat from the other substrate is applied to the reinforcing member; and
sealing the respective peripheral edge portions of the pair of substrates together after the cooling.

2. A method of manufacturing an image display device, which comprises an envelope which has a pair of substrates, opposed to each other and having respective peripheral edge portions sealed together, and reinforcing members interposed between the pair of substrates, the method comprising:
providing the reinforcing members on one of the pair of substrates with;
locating the pair of substrates opposite each other with the reinforcing member and a space therebetween;
heating the substrates opposed to each other with the space therebetween in a vacuum, thereby degassing the substrates;
cooling the pair of substrates in a manner such that the space between the pair of substrates is narrower than the space for the heating operation and that radiant heat from the other substrate is applied to the reinforcing member to reduce a difference in temperature between the reinforcing member and the substrate on which the reinforcing member is provided; and
sealing the respective peripheral edge portions of the pair of substrates together in a vacuum after the cooling.

3. The method of manufacturing an image display device according to claim 2, wherein the temperature difference is kept within about 15° C. during the cooling.

4. A method of manufacturing an image display device, wherein the image display device is manufactured by providing one of a pair of substrates with a reinforcing member, opposing the pair of substrates to each other with the reinforcing member therebetween, and sealing together respective peripheral edge portions of the substrates inside which a vacuum is formed, the method comprising:
a heating process for heating the pair of substrates with respective plate surfaces thereof opposed to each other; and a cooling process for cooling the pair of substrates heat-treated in the heating process with the respective plate surfaces thereof opposed to each other,
the space between the pair of substrates being made narrower in the cooling process than in the heating process so that a difference in temperature between the reinforcing member and the substrate which supports the reinforcing member when the substrates are cooled is reduced by radiant heat from the other substrate.

5. The method of manufacturing an image display device according to claim 1, wherein the space between the pair of substrates being heated is set to a distance such that gas degassed from the substrates never builds up between the substrates.

6. The method of manufacturing an image display device according to claim 1, wherein each of the reinforcing members is formed of a belt-shaped plate, and the plurality of reinforcing members are individually located in an upright state at predetermined intervals on the one substrate.

7. The method of manufacturing an image display device according to claim 1, wherein the pair of substrates are formed of a front substrate provided with a phosphor screen and a metal back and a rear substrate provided with the reinforcing member and a group of electron emitting elements.

8. An apparatus for manufacturing an image display device, wherein a vacuum envelope of the image display device is manufactured by providing reinforcing members on one of a pair of substrates, opposing the pair of substrates to each other with the reinforcing member therebetween, and sealing together respective peripheral edge portions of the substrates inside which a vacuum is formed, the apparatus comprising:
heating means for heating the pair of substrates with respective plate surfaces thereof opposed to each other at a predetermined distance from each other; and
cooling means for cooling the pair of heat-treated substrates in a manner such that the respective plate surfaces thereof are opposed closer to each other than in the heating operation and that a difference in temperature between the reinforcing member and the substrate which supports the reinforcing member is reduced by radiant heat from the substrate without the reinforcing member.

9. The apparatus for manufacturing an image display device according to claim 8, wherein each of the reinforcing members is formed of a belt-shaped plate, and the plurality of reinforcing members are individually located in an upright state at predetermined intervals in one direction on the one substrate and between opposite ends thereof in the other direction.

10. The apparatus for manufacturing an image display device according to claim 9, wherein the pair of substrates are formed of a front substrate provided with a phosphor screen and a metal back and a rear substrate provided with the reinforcing members and a group of electron emitting elements.

11. The apparatus for manufacturing an image display device according to claim 10, which comprises support means for supporting the pair of substrates in a manner such that the space between the pair of substrates being heated is widened to a distance suited for smooth degassing of the substrates.
